(19) United States
(12) Patent Application Publication
(10) Pub. No.: US 2011/0257062 A1
(43) Pub. Date: Oct. 20, 2011

(54) LIQUID LAUNDRY DETERGENT COMPOSITION COMPRISING A SOURCE OF PERACID AND HAVING A PH PROFILE THAT IS CONTROLLED WITH RESPECT TO THE PKA OF THE SOURCE OF PERACID

(76) Inventors: Robert Richard Dykstra, West Chester, OH (US); Eugene Joseph Pancheri, Montgomery, OH (US)

(21) Appl. No.: 13/084,827

(22) Filed: Apr. 12, 2011

Related U.S. Application Data
(60) Provisional application No. 61/325,408, filed on Apr. 19, 2010.

(51) Int. Cl. C11D 3/60; C11D 17/00

(52) U.S. Cl. 510/303

(57) ABSTRACT

The present invention relates to a non-unit dose liquid laundry detergent composition suitable for use in a single-compartment container comprising:
(a) detersive surfactant;
(b) from 0 wt % to 20 wt % water;
(c) source of peracid;
(d) optionally, from 0 wt % to 5 wt % citric acid; and
(e) optionally, from 0 wt % to 5 wt % fatty acid,
wherein the pH of the undiluted composition is at least 0.5 pH units higher than the pKa of the source of peracid,
and wherein upon dilution in de-ionized water to a concentration of 1 g/L at 20° C., the composition forms a wash liquor, wherein the equilibrium pH of the wash liquor is at least 0.5 pH units lower than the pKa of the source of peracid.

### CROSS REFERENCE TO RELATED APPLICATION

This application claims priority to U.S. Provisional Application No. 61/325,408, filed Apr. 19, 2010.

### FIELD OF THE INVENTION

The present invention relates to liquid laundry detergent compositions. The liquid laundry detergent compositions are in non-unit dose form, and are suitable for use in a single-compartment container. The liquid laundry detergent compositions comprise a source of peracid, and have a pH profile that is controlled with respect to the pKa of the source of peracid. The pH profile is such that in undiluted form, the pH is above the pKa of the source of peracid, but upon dilution with water the pH is reduced to below the pKa of the source of peracid. Preferably, the compositions also comprise an oxaziridinium-based bleach catalyst, and an alkanolammonium compound, and the pH profile of the composition is also controlled with respect to the pKa of the alkanolammonium compound such that upon dilution in water, the pH is reduced to below the pKa of the alkanolammonium compound.

### BACKGROUND OF THE INVENTION

Liquid laundry detergent formulators have for many years attempted to incorporate bleach into the formulation. For example, attempts have been made to formulate liquid detergent compositions for use in dual compartment containers, such as dual compartment bottles, which allow the detergent formulator to separate the bleach ingredients from the bleach sensitive ingredients. Other attempts have been to suspend solid bleach ingredients in a liquid and to then enclose the liquid in a film so as to form a unit dose pouch.

However, there is still an unmet consumer need for a bleach-containing liquid laundry product that is not a dual compartment bottle, and is not a unit dose form, but instead allows the consumer to vary and choose the dose according to their needs and desires. Such products are very difficult to formulate and achieve good storage stability and a good consistent dosing profile.

Dual compartment bottle approaches suffer from poor accurate dosing, as the execution relies on ensuring consistent dosing occurs from both containers, and this approach also involve expensive, complicated and often bulky packaging, which the consumers do not particularly desire.

The inventors have overcome these problems by providing a bleach-containing liquid detergent composition that is not in unit-dose form, and is suitable for use in single compartment containers, such as the conventional single compartment bottles currently being used in the market, thus negating the need for expensive and elaborate developments in dual compartment packaging to enable the use of bleach-containing liquid laundry detergent products.

The inventors have found that careful control of the pH of the undiluted liquid laundry detergent composition with respect to the pKa of the source of peracid coupled to a dynamic pH profile upon dilution with water that differs from the pH of the undiluted composition provides improved bleach stability and bleaching performance. The inventors have found that this is particularly beneficial when the source of peracid is a pre-formed peracid, especially phthalimido peroxy caproic acid. In addition, the incorporation of a bleach catalyst into the composition further improves the bleaching performance of this system. The inventors have also found that the addition of alkanolammonium compounds such as mono-ethanolamine, diethanolamine and/or triethanolamine, to aid in the compaction of the liquid laundry detergent composition can also be achieved and good bleaching performance can also be obtained when the dynamic pH profile of composition upon dilution in water is carefully controlled with respect to the pKa of the alkanolammonium compounds.

Without wishing to be bound by theory, the inventors believe that when the pHof the wash liquor is kept well below the pKa of the alkanolammonium, the concentration of free (i.e. non-protonated) alkanolammonium is kept as low as possible. This ensures that the negative effects of the alkanolammonium on the bleach system, especially when the bleach system comprises specific oxaziridinium-based bleach catalysts, is reduced. Without wishing to be bound by theory, the inventors have found that only alkanolammonium in its free (i.e. unprotonated form), deactivates bleach catalysts such as oxaziridinium based bleach catalysts, and negates their ability to boost the bleaching performance of the composition, which leads to a significant loss of bleaching performance. Controlling the pH of the wash liquor to greatly reduce the concentration of free (i.e. unprotonated) alkanolammonium, ensures compatibility with the bleach system.

Whilst neutralising anionic detersive surfactants with alkanolammonium helps compact the liquid laundry detergent formulation, and for the reasons described above, the control of the pH profile ensures the bleach compatibility of such surfactant systems, it is desirable that the amount of free alkanolamine (i.e. the amount of alkanolamine incorporated into the composition that is in excess of the stoichiometric amount required to neutralise the anionic detersive surfactant acid precursors, is kept to a minimum or even substantially avoided. By substantially avoided it is meant that no deliberately added alkanolammonium in excess of the amount required to neutralise the anionic detersive surfactant acid precursors is incorporated into the product.

Furthermore, the pH profile of the composition of the present invention also ensures good hueing profile, if hueing agents are incorporated into the product.

### SUMMARY OF THE INVENTION

The present invention relates to a composition as defined by claim 1.

### DETAILED DESCRIPTION OF THE INVENTION

Liquid laundry detergent composition. The liquid laundry detergent composition is a non-unit dose liquid laundry detergent composition that is suitable for use in a single-compartment container. The composition is in the form a liquid, typically comprising a single continuous liquid phase that optionally comprises a discontinuous particulate solid phase suspended in the single continuous liquid phase. The composition typically does not comprise two or more continuous liquid phases, is not part of a multi-compartment pouch, and is not dispensed from a multi-compartment container. The composition is in non-unit dose form.

The composition can be any liquid form, for example a liquid or gel form, or any combination thereof. However, it is extremely highly preferred for the composition to be in gel form.

The composition is a fully finished laundry detergent composition. The composition is not just a component of a laundry detergent composition that can be incorporated into a laundry detergent composition, it is a fully finished laundry detergent composition. That said, it is within the scope of the present invention for an additional rinse additive composition (e.g. fabric conditioner or enhancer), or a main wash additive composition (e.g. bleach additive) to also be used in combination with the liquid laundry detergent composition during the method of the present invention. Although, it may be preferred for no bleach additive composition is used in combination with the laundry detergent composition during the method of the present invention.

The composition typically comprises: (a) detersive surfactant; (b) from 0 wt % to 20 wt % water; (c) source of peracid; (d) optionally, from 0 wt % to 5 wt % citric acid; and (e) optionally, from 0 wt % to 5 wt % fatty acid, wherein the pH of the undiluted composition is at least 0.5 pH units higher than the pKa of the source of peracid, and wherein upon dilution in de-ionized water to a concentration of 1 g/L at 20° C., the composition forms a wash liquor, wherein the equilibrium pH of the wash liquor is at least 0.5 pH units lower than the pKa of the source of peracid.

Preferably the composition is a non-unit dose liquid laundry detergent composition suitable for use in a single-compartment container comprising: (a) detersive surfactant; (b) from 0 wt % to 20 wt % water; (c) source of peracid; (d) oxaziridinium-based bleach catalyst having the formula:

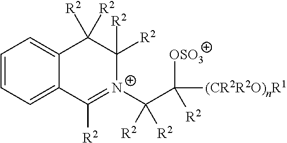

wherein: R¹ is selected from the group consisting of: H, a branched alkyl group containing from 3 to 24 carbons, and a linear alkyl group containing from 1 to 24 carbons; preferably, R¹ is a branched alkyl group comprising from 6 to 18 carbons, or a linear alkyl group comprising from 5 to 18 carbons, more preferably each R¹ is selected from the group consisting of: 2-propylheptyl, 2-butyloctyl, 2-pentylnonyl, 2-hexyldecyl, n-hexyl, n-octyl, n-decyl, n-dodecyl, n-tetradecyl, n-hexadecyl, n-octadecyl, iso-nonyl, iso-decyl, iso-tridecyl and iso-pentadecyl; R² is independently selected from the group consisting of: H, a branched alkyl group comprising from 3 to 12 carbons, and a linear alkyl group comprising from 1 to 12 carbons; preferably R² is independently selected from H and methyl groups; and n is an integer from 0 to 1; (e) alkanolammonium compound; (f) optionally, from 0 wt % to 5 wt % citric acid; and (g) optionally, from 0 wt % to 5 wt % fatty acid, wherein the pH of the undiluted composition is at least 1.0 pH unit higher than the pKa of the source of peracid, wherein upon dilution in de-ionized water to a concentration of 1 g/L at 20° C., the composition forms a wash liquor, wherein the equilibrium pH of the wash liquor is at least 1.0 pH unit lower than the pKa of the source of peracid, wherein upon dilution in de-ionized water to a concentration of 1 g/L at 20° C., the composition forms a wash liquor, wherein the equilibrium pH of the wash liquor is at least 2.0 pH units lower than the pKa of the alkanolammonium compound; wherein upon dilution in de-ionized water to a concentration of 1 g/L at 20° C., the composition has a pH profile such that: (i) one minute after dilution in water, the composition forms a wash liquor having an alkaline pH of 9.5 or greater; and (ii) one hour after dilution in water, the composition forms a wash liquor having an acid pH of 7.6 or less.

pH profile. The composition typically has a pH profile such that the pH of the undiluted composition is at least 0.5 pH units higher, preferably at least 1.0 pH units higher, or at least 1.5 pH units higher, or even at least 2.0 pH units higher, or at least 2.5 pH units higher, or even at least 3.0 pH units higher than the pKa of the source of peracid, and wherein upon dilution in de-ionized water to a concentration of 1 g/L at 20° C., the composition forms a wash liquor, wherein the equilibrium pH of the wash liquor is at least 0.5 pH units lower, or at least 1.0 pH units lower, or at least 1.5 pH units lower, or at least 2.0 pH units, or at least 2.5 pH units lower, or even at least 3.0 pH units lower than the pKa of the source of peracid.

It is highly preferred for the composition to comprise alkanolammonium compound and oxaziridinium-based bleach catalyst, and wherein upon dilution in de-ionized water to a concentration of 1 g/L at 20° C., the composition forms a wash liquor, wherein the equilibrium pH of the wash liquor is at least 0.5 pH units lower, or at least 1.0 pH units lower, or at least 1.5 pH units lower, or at least 2.0 pH units, or at least 2.5 pH units lower, or at least 3.0 pH units lower, or at least 3.5 pH units lower, or at least 4.0 pH units lower, or at least 4.5 pH units lower, or even at least 5.0 pH units lower than the pKa of the alkanolammonium compound.

Highly preferably, the composition has a pH profile such that upon dilution in de-ionized water to a concentration of 1 g/L at 20° C., the composition has a pH profile such that: (i) one minute after dilution in water, the composition forms a wash liquor having an alkaline pH of 8.5 pH units or greater, preferably 9.0 pH units or greater, or 9.5 pH units or greater, or even 10.0 pH units or greater; and (ii) one hour after dilution in water, the composition forms a wash liquor having a pH of 8.0 pH units or less, preferably 7.6 pH units or less, or even 7.0 pH units or less, or even less than 7.0 pH units, or even 6.5 pH units or less.

Alkanolammonium compound. Suitable alkanolammonium compounds include mono-ethanolamine (MEA) and/or tri-ethanolamine (TEA).

Acid source. The composition typically comprises an acid source. A preferred acid source is sodium bisulphate, and optionally palmitic acid. Preferably, the composition comprises sodium bisulphate in solid particulate form, wherein the solid particles of sodium bisulphate are suspended within a continuous liquid phase. Other acid sources include organic acids, such as citric acid. Other acid sources include acrylic acid, maleic acid (or maleic anhydride), fumaric acid, itaconic acid, aconitic acid, mesaconic acid, citraconic acid, methylenemalonic acid, and any mixture thereof.

Typically, the acid source is capable of releasing acidity into the wash liquor slowly, especially relative to the release of alkalinity. This can be achieved, for example by controlling the particle size distribution of the acid source, or by ensuring the acid source is, at least partially, preferably substantially completely, coated.

Preferably, the composition comprises sodium bisulphate and palmitic acid in solid co-particulate form, wherein the palmitic acid at least partially coats the sodium bisulphate, and the solid co-particles of sodium bisulphate and palmitic acid form a discontinuous solid phase that is suspended within a continuous liquid phase.

Alkalinity source. The composition may comprises an alkalinity source. Preferred alkalinity source includes silicate salt, preferably metasilicate, such as sodium metasilicate.

Another preferred alkalinity source is sodium hydroxide. Typically, the alkalinity source is capable of releasing alkalinity into the wash liquor very quickly, especially relative to the release of acid. This can be achieved, for example by controlling the particle size distribution of the alkalinity source, or by ensuring the alkalinity source is substantially uncoated.

Bleach catalyst. Preferably the composition comprises bleach catalyst. Preferred bleach catalysts include oxaziridinium-based bleach catalysts, transition metal bleach catalysts, bleaching enzymes, and any combination thereof.

Oxaziridinium-based bleach catalyst. Preferably, the composition comprises oxaziridinium-based bleach catalyst. The oxaziridinium-based bleach catalyst is capable of forming an oxazirdinium moiety; suitable oxaziridinium-based bleach catalysts include iminium compounds. Preferably the oxaziridinium-based bleach catalyst has the formula:

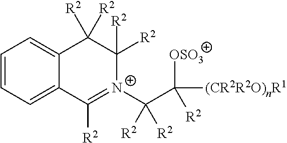

wherein: R¹ is selected from the group consisting of: H, a branched alkyl group containing from 3 to 24 carbons, and a linear alkyl group containing from 1 to 24 carbons; preferably, R¹ is a branched alkyl group comprising from 6 to 18 carbons, or a linear alkyl group comprising from 5 to 18 carbons, more preferably each R¹ is selected from the group consisting of: 2-propylheptyl, 2-butyloctyl, 2-pentylnonyl, 2-hexyldecyl, n-hexyl, n-octyl, n-decyl, n-dodecyl, n-tetradecyl, n-hexadecyl, n-octadecyl, iso-nonyl, iso-decyl, iso-tridecyl and iso-pentadecyl; R² is independently selected from the group consisting of: H, a branched alkyl group comprising from 3 to 12 carbons, and a linear alkyl group comprising from 1 to 12 carbons; preferably R² is independently selected from H and methyl groups; and n is an integer from 0 to 1.

Pre-formed peracid. The composition preferably comprises a pre-formed peracid or salt thereof. The pre-peroxyacid or salt thereof is typically either a peroxycarboxylic acid or salt thereof, or a peroxysulphonic acid or salt thereof. The pre-formed peroxyacid or salt thereof is preferably a peroxycarboxylic acid or salt thereof, typically having a chemical structure corresponding to the following chemical formula:

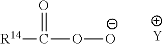

wherein: R¹⁴ is selected from alkyl, aralkyl, cycloalkyl, aryl or heterocyclic groups; the R¹⁴ group can be linear or branched, substituted or unsubstituted; and Y is any suitable counter-ion that achieves electric charge neutrality, preferably Y is selected from hydrogen, sodium or potassium. Preferably, R¹⁴ is a linear or branched, substituted or unsubstituted C₆₋₉ alkyl. Preferably, the peroxyacid or salt thereof is selected from peroxyhexanoic acid, peroxyheptanoic acid, peroxyoctanoic acid, peroxynonanoic acid, peroxydecanoic acid, any salt thereof, or any combination thereof. Preferably, the peroxyacid or salt thereof has a melting point in the range of from 30° C. to 60° C.

The pre-formed peroxyacid or salt thereof can also be a peroxysulphonic acid or salt thereof, typically having a chemical structure corresponding to the following chemical formula:

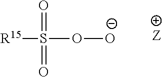

wherein: R¹⁵ is selected from alkyl, aralkyl, cycloalkyl, aryl or heterocyclic groups; the R¹⁵ group can be linear or branched, substituted or unsubstituted; and Z is any suitable counter-ion that achieves electric charge neutrality, preferably Z is selected from hydrogen, sodium or potassium. Preferably R¹⁵ is a linear or branched, substituted or unsubstituted C₆₋₉ alkyl.

The pre-formed peroxyacid or salt thereof may be in an encapsulated, preferably molecularly encapsulated, form. Typically, the pre-formed peroxyacid molecules are individually separated from each other by any suitable molecular encapsulation means.

A highly preferred pre-formed peracid is phthalimido peroxy caproic acid. Phthalimido peroxycaproic acid is also known as: phthalimido peroxycaproic acid; 2H-Isoindole-2-hexaneperoxoic acid, 1,3-dihydro-1,3-dioxo-; 5-(Phthalimido)percaproic acid; 6-(Phthalimidoperoxy)hexanoic acid; 6-Phthalimidohexaneperoxoic acid; Eureco; Eureco HC; Eureco HCL 11; Eureco HCL 17; Eureco LX; Eureco W; Phthalimidoperhexanoic acid; e-(Phthalimidoperoxy)hexanoic acid; and 1,3-dihydro-1,3-dioxo-2H-Isoindole-2-hexaneperoxoic aci. The CAS number is 128275-31-0.

Phthalimido peroxycaproic acid has the following chemical structure:

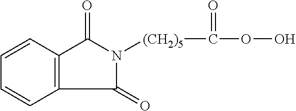

Detersive surfactant. The detersive surfactant typically comprises anionic detersive surfactant and non-ionic surfactant, wherein preferably the weight ratio of anionic detersive surfactant to non-ionic detersive surfactant is greater than 1:1, preferably greater than 1.5:1, or even greater than 2:1, or even greater than 2.5:1, or greater than 3:1.

The composition preferably comprises detersive surfactant, preferably from 10 wt % to 40 wt %, preferably from 12 wt %, or from 15 wt %, or even from 18 wt % detersive surfactant. Preferably, the surfactant comprises alkyl benzene sulphonate and one or more detersive co-surfactants. The surfactant preferably comprises C₁₀-C₁₃ alkyl benzene sulphonate and one or more co-surfactants. The co-surfactants preferably are selected from the group consisting of C₁₂-C₁₈ alkyl ethoxylated alcohols, preferably having an average degree of ethoxylation of from 1 to 7; C₁₂-C₁₈ alkyl ethoxylated sulphates, preferably having an average degree of ethoxylation of from 1 to 5; and mixtures thereof. However, other surfactant systems may be suitable for use in the present invention.

Suitable detersive surfactants include anionic detersive surfactants, nonionic detersive surfactants, cationic detersive surfactants, zwitterionic detersive surfactants, amphoteric detersive surfactants and mixtures thereof.

Suitable anionic detersive surfactants include: alkyl sulphates; alkyl sulphonates; alkyl phosphates; alkyl phosphonates; alkyl carboxylates; and mixtures thereof. The anionic surfactant can be selected from the group consisting of: C₁₀-C₁₈ alkyl benzene sulphonates (LAS) preferably C₁₀-C₁₃ alkyl benzene sulphonates; C₁₀-C₂₀ primary, branched chain, linear-chain and random-chain alkyl sulphates (AS), typically having the following formula:

CH₃(CH₂)xCH₂—OSO₃⁻M⁺

wherein, M is hydrogen or a cation which provides charge neutrality, preferred cations are sodium and ammonium cations, wherein x is an integer of at least 7, preferably at least 9; C₁₀-C₁₈ secondary (2,3) alkyl sulphates, typically having the following formulae:

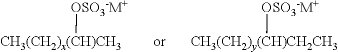

wherein, M is hydrogen or a cation which provides charge neutrality, preferred cations include sodium and ammonium cations, wherein x is an integer of at least 7, preferably at least 9; y is an integer of at least 8, preferably at least 9; C₁₀-C₁₈ alkyl alkoxy carboxylates; mid-chain branched alkyl sulphates as described in more detail in U.S. Pat. No. 6,020,303 and U.S. Pat. No. 6,060,443; modified alkylbenzene sulphonate (MLAS) as described in more detail in WO 99/05243, WO 99/05242, WO 99/05244, WO 99/05082, WO 99/05084, WO 99/05241, WO 99/07656, WO 00/23549, and WO 00/23548; methyl ester sulphonate (MES); alpha-olefin sulphonate (AOS) and mixtures thereof.

Preferred anionic detersive surfactants include: linear or branched, substituted or unsubstituted alkyl benzene sulphonate detersive surfactants, preferably linear C₈-C₁₈ alkyl benzene sulphonate detersive surfactants; linear or branched, substituted or unsubstituted alkyl benzene sulphate detersive surfactants; linear or branched, substituted or unsubstituted alkyl sulphate detersive surfactants, including linear C₈-C₁₈ alkyl sulphate detersive surfactants, C₁-C₃ alkyl branched C₈-C₁₈ alkyl sulphate detersive surfactants, linear or branched alkoxylated C₈-C₁₈ alkyl sulphate detersive surfactants and mixtures thereof; linear or branched, substituted or unsubstituted alkyl sulphonate detersive surfactants; and mixtures thereof.

Preferred alkoxylated alkyl sulphate detersive surfactants are linear or branched, substituted or unsubstituted C₈₋₁₈ alkyl alkoxylated sulphate detersive surfactants having an average degree of alkoxylation of from 1 to 30, preferably from 1 to 10. Preferably, the alkoxylated alkyl sulphate detersive surfactant is a linear or branched, substituted or unsubstituted C₈₋₁₈ alkyl ethoxylated sulphate having an average degree of ethoxylation of from 1 to 10. Most preferably, the alkoxylated alkyl sulphate detersive surfactant is a linear unsubstituted C₈₋₁₈ alkyl ethoxylated sulphate having an average degree of ethoxylation of from 3 to 7.

Preferred anionic detersive surfactants are selected from the group consisting of: linear or branched, substituted or unsubstituted, C₁₂₋₁₈ alkyl sulphates; linear or branched, substituted or unsubstituted, C₁₀₋₁₃ alkylbenzene sulphonates, preferably linear C₁₀₋₁₃ alkylbenzene sulphonates; and mixtures thereof. Highly preferred are linear C₁₀₋₁₃ alkylbenzene sulphonates. Highly preferred are linear C₁₀₋₁₃ alkylbenzene sulphonates that are obtainable, preferably obtained, by sulphonating commercially available linear alkyl benzenes (LAB); suitable LAB include low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic detersive surfactant is alkyl benzene sulphonate that is obtained by DETAL catalyzed process, although other synthesis routes, such as HF, may also be suitable.

Another suitable anionic detersive surfactant is alkyl ethoxy carboxylate. The anionic detersive surfactants are typically present in their salt form, typically being complexed with a suitable cation. Suitable counter-ions include Na⁺ and K⁺, substituted ammonium such as C₁-C₆ alkanolammnonium preferably mono-ethanolamine (MEA) tri-ethanolamine (TEA), di-ethanolamine (DEA), and any mixtures thereof.

Suitable cationic detersive surfactants include: alkyl pyridinium compounds; alkyl quaternary ammonium compounds; alkyl quaternary phosphonium compounds; alkyl ternary sulphonium compounds; and mixtures thereof. The cationic detersive surfactant can be selected from the group consisting of: alkoxylate quaternary ammonium (AQA) surfactants as described in more detail in U.S. Pat. No. 6,136,769; dimethyl hydroxyethyl quaternary ammonium as described in more detail in U.S. Pat. No. 6,004,922; polyamine cationic surfactants as described in more detail in WO 98/35002, WO 98/35003, WO 98/35004, WO 98/35005, and WO 98/35006; cationic ester surfactants as described in more detail in U.S. Pat. No. 4,228,042, U.S. Pat. No. 4,239,660, U.S. Pat. No. 4,260,529 and U.S. Pat. No. 6,022,844; amino surfactants as described in more detail in U.S. Pat. No. 6,221,825 and WO 00/47708, specifically amido propyldimethyl amine; and mixtures thereof. Preferred cationic detersive surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, preferred anions include halides (such as chloride), sulphate and sulphonate. Preferred cationic detersive surfactants are mono-C₆₋₁₈ alkyl mono-hydroxyethyl di-methyl quaternary ammonium chlorides. Highly preferred cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

Suitable non-ionic detersive surfactant can be selected from the group consisting of: C₈-C₁₈ alkyl ethoxylates, such as, NEODOL® non-ionic surfactants from Shell; C₆-C₁₂ alkyl phenol alkoxylates wherein the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA, as described in more detail in U.S. Pat. No. 6,150,322; C₁₄-C₂₂ mid-chain branched alkyl alkoxylates, BAEx, wherein x=from 1 to 30, as described in more detail in U.S. Pat. No. 6,153,577, U.S. Pat. No. 6,020,303 and U.S. Pat. No. 6,093,856; alkylpolysaccharides as described in more detail in U.S. Pat. No. 4,565,647, specifically alkylpolyglycosides as described in more detail in U.S. Pat. No. 4,483,780 and U.S. Pat. No. 4,483,779; polyhydroxy fatty acid amides as described in more detail in U.S. Pat. No. 5,332,528, WO 92/06162, WO 93/19146, WO 93/19038, and WO 94/09099; ether capped poly(oxyalkylated) alcohol surfactants as described in more detail in U.S. Pat. No. 6,482,994 and WO 01/42408; and mixtures thereof.

The non-ionic detersive surfactant could be an alkyl polyglucoside and/or an alkyl alkoxylated alcohol. Preferably the non-ionic detersive surfactant is a linear or branched, substituted or unsubstituted C₈₋₁₈ alkyl ethoxylated alcohol having an average degree of ethoxylation of from 1 to 10, more preferably from 3 to 7.

Suitable zwitterionic and/or amphoteric detersive surfactants include alkanolamine sulpho-betaines.

It may be preferred for the composition to comprise branched anionic detersive surfactant and/or branched non-ionic detersive surfactant. Preferably, the branched anionic detersive surfactant and/or branched non-ionic detersive surfactant are derived from natural sources, preferably wherein the natural sources include bio-derived isoprenoids, most preferably farnescene.

Polymers. The composition preferably comprises polymer. Suitable polymers are selected from amphilic alkoxylated grease cleaning polymer and random graft co-polymers. Such polymers are described in more detail below. Suitable polymers include polyamines, preferably polyethylene imines, most preferably alkoxylated polyethylene imines. Other suitable polymers include dye transfer inhibitors, such as polyvinyl pyrrolidone polymer, polyamine N-oxide polymer, co-polymer of N-vinylpyrrolidone and N-vinylimidazole polymers. Non-polymeric dye transfer inhibitors may also be used, such as manganese phthalocyanine, peroxidases, and mixtures thereof.

Amphiphilic alkoxylated grease cleaning polymer. Amphiphilic alkoxylated grease cleaning polymers of the present invention refer to any alkoxylated polymers having balanced hydrophilic and hydrophobic properties such that they remove grease particles from fabrics and surfaces. Specific embodiments of the amphiphilic alkoxylated grease cleaning polymers of the present invention comprise a core structure and a plurality of alkoxylate groups attached to that core structure.

The core structure may comprise a polyalkylenimine structure comprising, in condensed form, repeating units of formulae (I), (II), (III) and (IV):

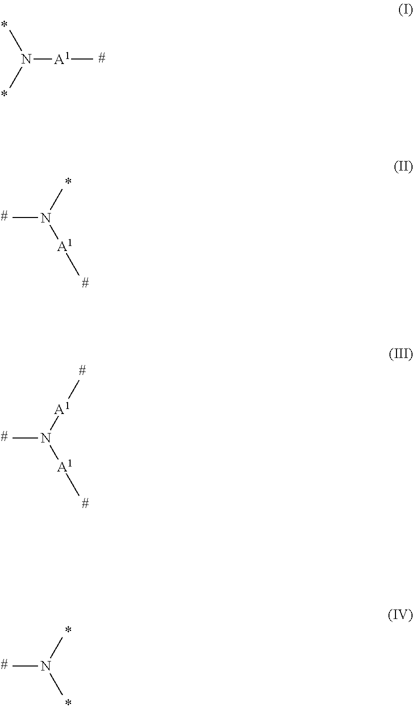

wherein # in each case denotes one-half of a bond between a nitrogen atom and the free binding position of a group A′ of two adjacent repeating units of formulae (I), (II), (III) or (IV); * in each case denotes one-half of a bond to one of the alkoxylate groups; and A¹ is independently selected from linear or branched C₂-C₆-alkylene; wherein the polyalkylenimine structure consists of 1 repeating unit of formula (I), x repeating units of formula (II), y repeating units of formula (III) and y+1 repeating units of formula (IV), wherein x and y in each case have a value in the range of from 0 to about 150; where the average weight average molecular weight, Mw, of the polyalkylenimine core structure is a value in the range of from about 60 to about 10,000 g/mol.

The core structure may alternatively comprise a polyalkanolamine structure of the condensation products of at least one compound selected from N-(hydroxyalkyl)amines of formulae (I.a) and/or (I.b),

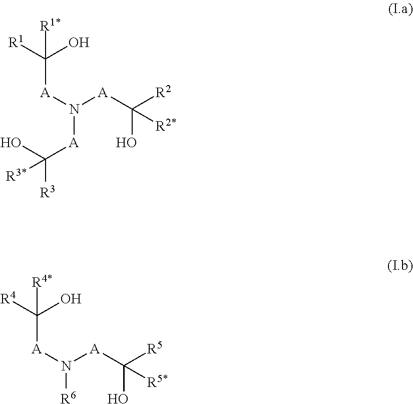

wherein A are independently selected from C₁-C₆-alkylene; R¹, R¹*, R², R²*, R³, R³*, R⁴, R⁴*, R⁵ and R⁵* are independently selected from hydrogen, alkyl, cycloalkyl or aryl, wherein the last three mentioned radicals may be optionally substituted; and R⁶ is selected from hydrogen, alkyl, cycloalkyl or aryl, wherein the last three mentioned radicals may be optionally substituted.

The plurality of alkylenoxy groups attached to the core structure are independently selected from alkylenoxy units of the formula (V)

*A²-OₘCH₂—CH₂—OₙA³-Oₚ—R (V)

wherein * in each case denotes one-half of a bond to the nitrogen atom of the repeating unit of formula (I), (II) or (IV); A² is in each case independently selected from 1,2-propylene, 1,2-butylene and 1,2-isobutylene; A³ is 1,2-propylene; R is in each case independently selected from hydrogen and Cᵢ-C₄-alkyl; m has an average value in the range of from 0 to about 2; n has an average value in the range of from about 20 to about 50; and p has an average value in the range of from about 10 to about 50.

Specific embodiments of the amphiphilic alkoxylated grease cleaning polymers may be selected from alkoxylated polyalkylenimines having an inner polyethylene oxide block and an outer polypropylene oxide block, the degree of ethoxylation and the degree of propoxylation not going above or below specific limiting values. Specific embodiments of the alkoxylated polyalkylenimines according to the present invention have a minimum ratio of polyethylene blocks to polypropylene blocks (n/p) of about 0.6 and a maximum of about 1.5(x+2y+1)^{1/2}. Alkoxykated polyalkyenimines having an n/p ratio of from about 0.8 to about 1.2(x+2y+1)^{1/2} have been found to have especially beneficial properties.

The alkoxylated polyalkylenimines according to the present invention have a backbone which consists of primary, secondary and tertiary amine nitrogen atoms which are attached to one another by alkylene radicals A and are randomly arranged. Primary amino moieties which start or terminate the main chain and the side chains of the polyalkylenimine backbone and whose remaining hydrogen atoms are subsequently replaced by alkylenoxy units are referred to as repeating units of formulae (I) or (IV), respectively. Secondary amino moieties whose remaining hydrogen atom is subsequently replaced by alkylenoxy units are referred to as repeating units of formula (II). Tertiary amino moieties which branch the main chain and the side chains are referred to as repeating units of formula (III).

Since cyclization can occur in the formation of the polyalkylenimine backbone, it is also possible for cyclic amino moieties to be present to a small extent in the backbone. Such polyalkylenimines containing cyclic amino moieties are of course alkoxylated in the same way as those consisting of the noncyclic primary and secondary amino moieties.

The polyalkylenimine backbone consisting of the nitrogen atoms and the groups A¹, has an average molecular weight Mw of from about 60 to about 10,000 g/mole, preferably from about 100 to about 8,000 g/mole and more preferably from about 500 to about 6,000 g/mole.

The sum (x+2y+1) corresponds to the total number of alkylenimine units present in one individual polyalkylenimine backbone and thus is directly related to the molecular weight of the polyalkylenimine backbone. The values given in the specification however relate to the number average of all polyalkylenimines present in the mixture. The sum (x+2y+2) corresponds to the total number amino groups present in one individual polyalkylenimine backbone.

The radicals A¹ connecting the amino nitrogen atoms may be identical or different, linear or branched C₂-C₆-alkylene radicals, such as 1,2-ethylene, 1,2-propylene, 1,2-butylene, 1,2-isobutylene, 1,2-pentanediyl, 1,2-hexanediyl or hexamethylen. A preferred branched alkylene is 1,2-propylene. Preferred linear alkylene are ethylene and hexamethylene. A more preferred alkylene is 1,2-ethylene.

The hydrogen atoms of the primary and secondary amino groups of the polyalkylenimine backbone are replaced by alkylenoxy units of the formula (V).

*A²-OₘCH₂CH₂—OₙA³Oₚ—R (V)

In this formula, the variables preferably have one of the meanings given below:

A² in each case is selected from 1,2-propylene, 1,2-butylene and 1,2-isobutylene; preferably A² is 1,2-propylene. A³ is 1,2-propylene; R in each case is selected from hydrogen and C₁-C₄-alkyl, such as methyl, ethyl, n-propyl, isopropyl, n-butyl, isobutyl and tert.-butyl; preferably R is hydrogen. The index m in each case has a value of 0 to about 2; preferably m is 0 or approximately 1; more preferably m is 0. The index n has an average value in the range of from about 20 to about 50, preferably in the range of from about 22 to about 40, and more preferably in the range of from about 24 to about 30. The index p has an average value in the range of from about 10 to about 50, preferably in the range of from about 11 to about 40, and more preferably in the range of from about 12 to about 30.

Preferably the alkylenoxy unit of formula (V) is a non-random sequence of alkoxylate blocks: By non-random sequence it is meant that the [-A²-O—]ₘ is added first (i.e., closest to the bond to the nitrogen atom of the repeating unit of formula (I), (II), or (III)), the [—CH₂—CH₂—O—]ₙ— is added second, and the [-A³-O—]ₚ is added third. This orientation provides the alkoxylated polyalkylenimine with an inner polyethylene oxide block and an outer polypropylene oxide block.

The substantial part of these alkylenoxy units of formula (V) is formed by the ethylenoxy units —[CH₂—CH₂—O)]ₙ— and the propylenoxy units —[CH₂—CH₂(CH₃)—O]ₚ—. The alkylenoxy units may additionally also have a small proportion of propylenoxy or butylenoxy units -[A²-O]ₘ—, i.e. the polyalkylenimine backbone saturated with hydrogen atoms may be reacted initially with small amounts of up to about 2 mol, especially from about 0.5 to about 1.5 mol, in particular from about 0.8 to about 1.2 mol, of propylene oxide or butylene oxide per mole of NH— moieties present, i.e. incipiently alkoxylated.

This initial modification of the polyalkylenimine backbone allows, if necessary, the viscosity of the reaction mixture in the alkoxylation to be lowered. However, the modification generally does not influence the performance properties of the alkoxylated polyalkylenimine and therefore does not constitute a preferred measure.

The amphiphilic alkoxylated grease cleaning polymers are present in the detergent and cleaning compositions of the present invention at levels ranging from about 0.05% to 10% by weight of the composition. Embodiments of the compositions may comprise from about 0.1% to about 5% by weight. More specifically, the embodiments may comprise from about 0.25 to about 2.5% of the grease cleaning polymer.

Random graft co-polymer. The random graft co-polymer comprises: (i) hydrophilic backbone comprising monomers selected from the group consisting of: unsaturated C₁-C₆ carboxylic acids, ethers, alcohols, aldehydes, ketones, esters, sugar units, alkoxy units, maleic anhydride, saturated polyalcohols such as glycerol, and mixtures thereof; and (ii) hydrophobic side chain(s) selected from the group consisting of: C₄-C₂₅ alkyl group, polypropylene, polybutylene, vinyl ester of a saturated C₁-C₆ mono-carboxylic acid, C₁-C₆ alkyl ester of acrylic or methacrylic acid, and mixtures thereof.

The polymer preferably has the general formula:

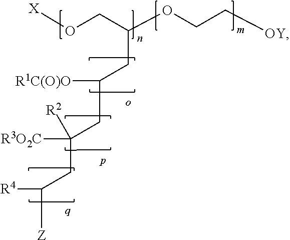

wherein X, Y and Z are capping units independently selected from H or a C₁₋₆ alkyl; each R¹ is independently selected from methyl and ethyl; each R² is independently selected from H and methyl; each R³ is independently a C₁₋₄ alkyl; and each R⁴ is independently selected from pyrrolidone and phenyl groups. The weight average molecular weight of the polyethylene oxide backbone is typically from about 1,000 g/mol to about 18,000 g/mol, or from about 3,000 g/mol to about 13,500 g/mol, or from about 4,000 g/mol to about 9,000 g/mol. The value of m, n, o, p and q is selected such that the pendant groups comprise, by weight of the polymer at least 50%, or from about 50% to about 98%, or from about 55% to about 95%, or from about 60% to about 90%. The polymer useful herein typically has a weight average molecular weight of from about 1,000 to about 100,000 g/mol, or preferably from about 2,500 g/mol to about 45,000 g/mol, or from about 7,500 g/mol to about 33,800 g/mol, or from about 10,000 g/mol to about 22,500 g/mol.

Soil release polymers. Suitable soil release polymers include polymers comprising at least one monomer unit selected from saccharide, dicarboxylic acid, polyol and combinations thereof, in random or block configuration. Other suitable soil release polymers include ethylene terephthalate-based polymers and co-polymers thereof, preferably co-polymers of ethylene terephthalate and polyethylene oxide in random or block configuration.

Anti-redeposition polymers. The composition may comprise anti-redeposition polymer, preferably from 0.1 wt % to 10 wt % anti-redeposition polymer. Suitable anti-redeposition polymers include carboxylate polymers, such as polymers comprising at least one monomer selected from acrylic acid, maleic acid (or maleic anhydride), fumaric acid, itaconic acid, aconitic acid, mesaconic acid, citraconic acid, methylenemalonic acid, and any mixture thereof. Suitable carboxylate polymers include.

Other suitable anti-redeposition polymers include polyethylene glycol, preferably having a molecular weight in the range of from 500 to 100,000 Da.

Carboxylate polymers. It may be preferred for the composition to comprise from above 0 wt % to 5 wt %, by weight of the composition, of polymeric carboxylate. The polymeric carboxylate can sequester free calcium ions in the wash liquor. The carboxylate polymers can also act as soil dispersants and can provide an improved particulate stain removal cleaning benefit.

The composition preferably comprises polymeric carboxylate. Preferred polymeric carboxylates include: polyacrylates, preferably having a weight average molecular weight of from 1,000Da to 20,000Da; co-polymers of maleic acid and acrylic acid, preferably having a molar ratio of maleic acid monomers to acrylic acid monomers of from 1:1 to 1:10 and a weight average molecular weight of from 10,000Da to 200,000Da, or preferably having a molar ratio of maleic acid monomers to acrylic acid monomers of from 0.3:1 to 3:1 and a weight average molecular weight of from 1,000Da to 50,000Da.

Deposition aids. The composition may comprise deposition aid. Suitable deposition aids are polysaccharides, preferably cellulosic polymers. Other suitable deposition aids include poly diallyl dimethyl ammonium halides (DADMAC), and co-polymers of DADMAC with vinyl pyrrolidone, acrylamides, imidazoles, imidazolinium halides, and mixtures thereof, in random or block configuration. Other suitable deposition aids include cationic guar gum, cationic cellulose such as cationic hydoxyethyl cellulose, cationic starch, cationic polyacylamides, and mixtures thereof.

Perfume microcapsule. The composition may comprise perfume in microcapsule form. Preferably, the composition comprises a perfume microcapsule. Preferred perfume microcapsules comprise melamine formaldehyde, urea formaldehyde, urea, or mixtures thereof.

Hueing agent. The composition may comprise hueing dye. Hueing dyes are formulated to deposit onto fabrics from the wash liquor so as to improve fabric whiteness perception. Preferably the hueing agent dye is blue or violet. It is preferred that the shading dye(s) have a peak absorption wavelength of from 550 nm to 650 nm, preferably from 570 nm to 630 nm. A combination of dyes which together have the visual effect on the human eye as a single dye having a peak absorption wavelength on polyester of from 550 nm to 650 nm, preferably from 570 nm to 630 nm. This may be provided for example by mixing a red and green-blue dye to yield a blue or violet shade.

Dyes are coloured organic molecules which are soluble in aqueous media that contain surfactants. Dyes are described in ‘Industrial Dyes’, Wiley VCH 2002, K. Hunger (editor). Dyes are listed in the Color Index International published by Society of Dyers and Colourists and the American Association of Textile Chemists and Colorists. Dyes are preferably selected from the classes of basic, acid, hydrophobic, direct and polymeric dyes, and dye-conjugates. Those skilled in the art of detergent formulation are able to select suitable hueing dyes from these publications. Polymeric hueing dyes are commercially available, for example from Milliken, Spartanburg, S.C., USA.

Examples of suitable dyes are direct violet 7 , direct violet 9 , direct violet 11, direct violet 26, direct violet 31, direct violet 35, direct violet 40, direct violet 41, direct violet 51, direct violet 66, direct violet 99, acid violet 50, acid blue 9, acid violet 17, acid black 1, acid red 17, acid blue 29, solvent violet 13, disperse violet 27 disperse violet 26, disperse violet 28, disperse violet 63 and disperse violet 77, basic blue 16, basic blue 65, basic blue 66, basic blue 67, basic blue 71, basic blue 159, basic violet 19, basic violet 35, basic violet 38, basic violet 48; basic blue 3, basic blue 75, basic blue 95, basic blue 122, basic blue 124, basic blue 141, thiazolium dyes, reactive blue 19, reactive blue 163, reactive blue 182, reactive blue 96, Liquitint® Violet CT (Milliken, Spartanburg, USA) and Azo-CM-Cellulose (Megazyme, Bray, Republic of Ireland).

Enzymes. The composition preferably comprises enzyme. Preferably, the composition comprises a relatively high level of enzymes.

It may be preferred for the composition to comprise at least a ternary enzyme system selected from protease, amylase, lipase and/or cellulase.

Lipase. Suitable lipases include those of bacterial or fungal origin. Chemically modified or protein engineered mutants are included. Examples of useful lipases include lipases from Humicola (synonym Thermomyces), e.g., from H. lanuginosa (T. lanuginosus) as described in EP 258 068 and EP 305 216 or from H. insolens as described in WO 96/13580, a Pseudomonas lipase, e.g., from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g., from B. subtilis (Dartois et al. (1993), Biochemica et Biophysica Acta, 1131, 253-360), B. stearothermophilus (JP 64/744992) or B. pumilus (WO 91/16422).

The lipase may be a “first cycle lipase” such as those described in U.S. Pat. No. 6,939,702 and US PA 2009/0217464. In one aspect, the lipase is a first-wash lipase, preferably a variant of the wild-type lipase from Thermomyces lanuginosus comprising T231R and N233R mutations. The wild-type sequence is the 269 amino acids (amino acids 23-291) of the Swissprot accession number Swiss-Prot O59952 (derived from Thermomyces lanuginosus (Humicola lanuginosa)). Preferred lipases would include those sold under the tradenames Lipex®, Lipolex® and Lipoclean® by Novozymes, Bagsvaerd, Denmark.

Preferably, the composition comprises a variant of Thermomyces lanuginosa lipase having >90% identity with the wild type amino acid and comprising substitution(s) at T231 and/or N233, preferably T231R and/or N233R (herein: “first wash lipase”).

Protease. Suitable proteases include metalloproteases and/or serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:
(a) subtilisins (EC 3.4.21.62), including those derived from Bacillus, such as Bacillus lentus, B. alkalophilus, B. subtilis, B. amyloliquefaciens, Bacillus pumilus and Bacillus gibsonii described in U.S. Pat. No. 6,312,936, U.S. Pat. No. 5,679,630, U.S. Pat. No. 4,760,025, U.S. Pat. No. 7,262,042 and WO09/021867.
(b) trypsin-type or chymotrypsin-type proteases, such as trypsin (e.g., of porcine or bovine origin), including the Fusarium protease described in WO 89/06270 and the chymotrypsin proteases derived from Cellumonas described in WO 05/052161 and WO 05/052146.
(c) metalloproteases, including those derived from Bacillus amyloliquefaciens described in WO 07/044993.

Preferred proteases include those derived from Bacillus gibsonii or Bacillus Lentus.

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark), those sold under the tradename Maxatase®, Maxacal®, Maxapem®, Properase®, Purafect®, Purafect Prime®, Purafect Ox®, FN3®, FN4®, Excellase® and Purafect OXP® by Genencor International, those sold under the tradename Opticlean® and Optimase® by Solvay Enzymes, those available from Henkel/Kemira, namely BLAP (sequence shown in FIG. 29 of U.S. Pat. No. 5,352,604 with the folowing mutations S99D+S101 R+S103A+V104I+G159S, hereinafter referred to as BLAP), BLAP R (BLAP with S3T+V41+V199M+V205I+L217D), BLAP X (BLAP with S3T+V4I+V205I) and BLAP F49 (BLAP with S3T+V4I+A194P+V199M+V205I+L217D)—all from Henkel/Kemira; and KAP (Bacillus alkalophilus subtilisin with mutations A230V+S256G+S259N) from Kao.

Preferably, the composition comprises a subtilisin protease selected from BLAP, BLAP R, BLAP X or BLAP F49.

Cellulase. Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. No. 4,435,307, U.S. Pat. No. 5,648,263, U.S. Pat. No. 5,691,178, U.S. Pat. No. 5,776,757 and WO 89/09259.

Especially suitable cellulases are the alkaline or neutral cellulases having colour care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. No. 5,457,046, U.S. Pat. No. 5,686,593, U.S. Pat. No. 5,763,254, WO 95/24471, WO 98/12307 and PCT/DK98/00299.

Commercially available cellulases include CELLUZYME®, and CAREZYME® (Novozymes A/S), CLAZINASE®, and PURADAX HA® (Genencor International Inc.), and KAC-500(B)® (Kao Corporation).

In one aspect, the cellulase can include microbial-derived endoglucanases exhibiting endo-beta-1,4-glucanase activity (E.C. 3.2.1.4), including a bacterial polypeptide endogenous to a member of the genus Bacillus which has a sequence of at least 90%, 94%, 97% and even 99% identity to the amino acid sequence SEQ ID NO:2 in U.S. Pat. No. 7,141,403) and mixtures thereof. Suitable endoglucanases are sold under the tradenames Celluclean® and Whitezyme® (Novozymes A/S, Bagsvaerd, Denmark).

Preferably, the composition comprises a cleaning cellulase belonging to Glycosyl Hydrolase family 45 having a molecular weight of from 17 kDa to 30 kDa, for example the endoglucanases sold under the tradename Biotouch® NCD, DCC and DCL (AB Enzymes, Darmstadt, Germany).

Amylase. Preferably, the composition comprises an amylase with greater than 60% identity to the AA560 alpha amylase endogenous to Bacillus sp. DSM 12649, preferably a variant of the AA560 alpha amylase endogenous to Bacillus sp. DSM 12649 having:
(a) mutations at one or more of positions 9, 26, 149, 182, 186, 202, 257, 295, 299, 323, 339 and 345; and
(b) optionally with one or more, preferably all of the substitutions and/or deletions in the following positions: 118, 183, 184, 195, 320 and 458, which if present preferably comprise R118K, D183*, G184*, N195F, R320K and/or R458K.

Suitable commercially available amylase enzymes include Stainzyme® Plus, Stainzyme®, Natalase, Termamyl®, Termamyl® Ultra, Liquezyme® SZ (all Novozymes, Bagsvaerd, Denmark) and Spezyme® AA or Ultraphlow (Genencor, Palo Alto, USA).

Choline oxidase. Preferably, the composition comprises a choline oxidase enzyme such as the 59.1 kDa choline oxidase enzyme endogenous to Arthrobacter nicotianae, produced using the techniques disclosed in D. Ribitsch et al., Applied Microbiology and Biotechnology, Volume 81, Number 5, pp 875-886, (2009).

Other enzymes. Other suitable enzymes are peroxidases/oxidases, which include those of plant, bacterial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257.

Commercially available peroxidases include GUARDZYME® (Novozymes A/S).

Other preferred enzymes include: pectate lyases sold under the tradenames Pectawash®, Pectaway®; mannanases sold under the tradenames Mannaway® (all from Novozymes A/S, Bagsvaerd, Denmark), and Purabrite® (Genencor International Inc., Palo Alto, Calif.); cutinases; phospholipases; and any mixture thereof.

Identity. The relativity between two amino acid sequences is described by the parameter “identity”. For purposes of the present invention, the alignment of two amino acid sequences is determined by using the Needle program from the EMBOSS package (http://emboss.org) version 2.8.0. The Needle program implements the global alignment algorithm described in Needleman, S. B. and Wunsch, C. D. (1970) J. Mol. Biol. 48, 443-453. The substitution matrix used is BLOSUM62, gap opening penalty is 10, and gap extension penalty is 0.5.

Enzyme stabilizer. The composition may comprise an enzyme stabilizer. Suitable enzyme stabilizers include polyols such as propylene glycol or glycerol, sugar or sugar alcohol, lactic acid, reversible protease inhibitor, boric acid, or a boric acid derivative, e.g., an aromatic borate ester, or a phenyl boronic acid derivative such as 4-formylphenyl boronic acid. It may be preferred for the composition to comprise a nil-boron enzyme stabilizer, preferably selected from polyols such as propylene glycol or glycerol, sugar or sugar alcohol. It may even be preferred for the composition to be substantially free of boron. By substantially free it is typically meant: “comprises no deliberately added”. Free of boron also typically includes free of sources of boron, such as borax.

Structurant. The composition may comprise a structurant selected from the group consisting of diglycerides and triglycerides, ethylene glycol distearate microcrystalline cellulose, cellulose-based materials, microfiber cellulose, biopolymers, xanthan gum, gellan gum, and mixtures thereof. A suitable structurant includes castor oil and its derivatives such as hydrogenated castor oil.

Solvent. The composition preferably comprises solvent. Preferred solvents include alcohols and/or glycols, preferably methanol, ethanol and/or propylene glycol. Preferably, the composition comprises no or minimal amounts of methanol and ethanol and instead comprises relatively high amounts of propylene glycol, for improved enzyme stability. Preferably, the composition comprises propylene glycol.

Suitable solvents include C₄-C₁₄ ethers and diethers, glycols, alkoxylated glycols, C₆-C₁₆ glycol ethers, alkoxylated aromatic alcohols, aromatic alcohols, aliphatic branched alcohols, alkoxylated aliphatic branched alcohols, alkoxylated linear C₁-C₅ alcohols, linear C₁-C₅ alcohols, amines, C₈-C₁₄ alkyl and cycloalkyl hydrocarbons and halohydrocarbons, and mixtures thereof.

Preferred solvents are selected from methoxy octadecanol, 2-(2-ethoxyethoxy)ethanol, benzyl alcohol, 2-ethylbutanol and/or 2-methylbutanol, 1-methylpropoxyethanol and/or 2-methylbutoxyethanol, linear C₁-C₅ alcohols such as methanol, ethanol, propanol, butyl diglycol ether (BDGE), butyltriglycol ether, tert-amyl alcohol, glycerol, isopropanol and mixtures thereof. Particularly preferred solvents which can be used herein are butoxy propoxy propanol, butyl diglycol ether, benzyl alcohol, butoxypropanol, propylene glycol, glycerol, ethanol, methanol, isopropanol and mixtures thereof. Other suitable solvents include propylene glycol and diethylene glycol and mixtures thereof.

Free water. The composition preferably comprises less than 10 wt %, or less than 5 wt %, or less than 4 wt % or less than 3 wt % free water, or less than 2 wt % free water, or less than 1 wt % free water, and may even be anhydrous, typically comprising no deliberately added free water. Free water is typically measured using Karl Fischer titration. 2 g of the laundry detergent composition is extracted into 50 ml dry methanol at room temperature for 20 minutes and analyse 1 ml of the methanol by Karl Fischer titration.

Other detergent ingredients. The composition typically comprises other detergent ingredients. Suitable detergent ingredients include: transition metal catalysts; enzymes such as amylases, carbohydrases, cellulases, laccases, lipases, bleaching enzymes such as oxidases and peroxidases, proteases, pectate lyases and mannanases; suds suppressing systems such as silicone based suds suppressors; brighteners; hueing agents; photobleach; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as oligomers produced by the condensation of imidazole and epichlorhydrin; soil dispersants and soil anti-redeposition aids such as alkoxylated polyamines and ethoxylated ethyleneimine polymers; anti-redeposition components such as polyesters; perfumes such as perfume microcapsules; soap rings; aesthetic particles; dyes; fillers such as sodium sulphate; although it is preferred for the composition to be substantially free of fillers; silicate salt such as sodium silicate, including 1.6 R and 2.0 R sodium silicate, or sodium metasilicate; co-polyesters of di-carboxylic acids and diols; cellulosic polymers such as methyl cellulose, carboxymethyl cellulose, hydroxyethoxycellulose, or other alkyl or alkylalkoxy cellulose; and any combination thereof.

Method of laundering fabric. The method of laundering fabric comprises the step of contacting the liquid laundry detergent composition to water to form a wash liquor, and laundering fabric in said wash liquor. The liquid laundry detergent composition is described in more detail above. The fabric may be contacted to the water prior to, or after, or simultaneous with, contacting the laundry detergent composition with water.

Typically, the wash liquor is formed by contacting the laundry detergent to water in such an amount so that the concentration of laundry detergent composition in the wash liquor is from above 0 g/l to 4 g/l, preferably from 1 g/l, and preferably to 3.5 g/l, or to 3.0 g/l, or to 2.5 g/l, or to 2.0g/l, or to 1.5 g/l, or even to 1.0 g/l, or even to 0.5 g/l.

Highly preferably, the method of laundering fabric is carried out in a front-loading automatic washing machine. In this embodiment, the wash liquor formed and concentration of laundry detergent composition in the wash liquor is that of the main wash cycle. Any input of water during any optional rinsing step(s) that typically occurs when laundering fabric using a front-loading automatic washing machine is not included when determining the volume of the wash liquor. Of course, any suitable automatic washing machine may be used, although it is extremely highly preferred that a front-loading automatic washing machine is used.

It is highly preferred for the wash liquor to comprise 40 litres or less of water, preferably 35 litres or less, preferably 30 litres or less, preferably 25 litres or less, preferably 20 litres or less, preferably 15 litres or less, preferably 12 litres or less, preferably 10 litres or less, preferably 8 litres or less, or even 6 litres or less of water. Preferably, the wash liquor comprises from above 0 to 15 litres, or from 1 litre, or from 2 litres, or from 3 litres, and preferably to 12 litres, or to 10 litres, or even to 8 litres of water. Most preferably, the wash liquor comprises from 1 litre, or from 2 litres, or from 3 litres, or from 4 litres, or even from 5 litres of water.

Typically from 0.01 kg to 2 kg of fabric per litre of wash liquor is dosed into said wash liquor. Typically from 0.01 kg, or from 0.02 kg, or from 0.03 kg, or from 0.05 kg, or from 0.07 kg, or from 0.10 kg, or from 0.12 kg, or from 0.15 kg, or from 0.18 kg, or from 0.20 kg, or from 0.22 kg, or from 0.25 kg fabric per litre of wash liquor is dosed into said wash liquor.

Preferably 50 g or less, more preferably 45 g or less, or 40 g or less, or 35 g or less, or 30 g or less, or 25 g or less, or 20 g or less, or even 15 g or less, or even 10 g or less of laundry detergent composition is contacted to water to form the wash liquor.

Remarks. The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### EXAMPLES

| | Example | | | | |
|---|---|---|---|---|---|
| | A | B | C | D | E |
| Ingredient | Wt % | Wt % | Wt % | Wt % | Wt % |
| The following ingredients | | | | | |
| are in the form of | | | | | |
| a continuous liquid phase | | | | | |
| Sodium alkyl ether sulfate | 20.5 | 22 | 18 | 26 | 29.7 |
| Branched alcohol sulfate | 5.8 | 4.8 | 6.4 | 8.4 | 7.7 |
| Linear Alkylbenzene | 2.5 | 2.5 | 2.1 | 6.1 | 8.4 |
| Sulfonic Acid | | | | | |
| Alkyl ethoxylate | 0.8 | 1.1 | 1.4 | 2.4 | 1.4 |
| C12-14 Amine oxide | 0.2 | 0.2 | — | 1.1 | — |
| Citric Acid | — | — | 1.2 | 0.4 | — |
| C12-18 Fatty Acid | — | 1.0 | 0.9 | — | — |
| Protease | 0.7 | — | — | 0.6 | 0.6 |
| Amylase | 0.4 | — | — | 0.4 | — |
| Borax | 3.0 | — | — | 2.2 | — |
| Calcium and Sodium formate | 0.22 | 0.31 | 0.22 | 0.35 | — |
| Amine Ethoxylate Polymers | 1.2 | 1.0 | — | 1.2 | — |
| Zwitterionic Amine | 1.0 | 1.5 | — | 3.1 | — |
| Ethoxylate | | | | | |
| Polymers | | | | | |
| Diethylene Triamine Penta | 0.35 | 0.25 | 0.61 | 0.44 | 0.41 |
| Acetic Acid (DTPA) | | | | | |
| Fluorescent whitening | 0.2 | 0.3 | 0.3 | 0.3 | — |
| agent(s) | | | | | |
| Ethanol | 2.9 | 3.9 | 2.0 | 1.6 | 4.3 |
| Propane diol | 5.0 | 4.0 | 2.0 | 3.1 | 6.5 |
| Diethylene glycol (DEG) | 2.6 | 3.6 | 4.6 | 4.7 | 4.9 |
| Poly ethylene glycol 4000 | 0.15 | — | — | — | — |
| Monoethanolamine (MEA) | 2.7 | 3.7 | 5.1 | 5.1 | — |
| Sodium hydroxide (NaOH) | 3.8 | 1.2 | 2.0 | — | 3.1 |
| Sodium Cumene Sulfonate | — | 0.08 | — | — | — |
| Silicone Suds Suppressor | 0.11 | 0.10 | — | — | 0.06 |
| Perfume | 0.5 | 0.3 | 1.2 | — | 0.8 |
| Perfume microcapsules | 0.4 | — | — | 0.9 | — |
| Formaldehyde scavenger | 0.1 | — | — | 0.2 | — |
| Hueing agent and dyes | 0.11 | 0.13 | 0.0.8 | 0.10 | — |
| The following ingredients | | | | | |
| are in the form of a | | | | | |
| discontinuous solid | | | | | |
| particulate phase | | | | | |
| suspended within the | | | | | |
| continuous liquid phase | | | | | |
| 6-(Phthalimidoperoxy) | — | 1.2 | 3.0 | 2.1 | 1.0 |
| hexanoic acid (PAP) | | | | | |
| Metal catalyst | — | — | 0.05 | — | — |
| [Mn(Bcyclam*)Cl₂] | | | | | |
| Sulphuric acid mono-[2-(3,4- | — | 0.05 | — | 0.16 | — |
| dihydro-isoquinolin-2-yl)-1- | | | | | |
| (2-butyl-octyloxymethyl)- | | | | | |
| ethyl]ester, internal salt | | | | | |
| N-methyl-3,4- | 0.09 | — | — | — | 0.14 |
| dihydroisoquinolinium | | | | | |
| tetrafluoroborate | | | | | |
| Sodium percarbonate | 4 | — | — | — | — |
| Sodium | 1.4 | — | — | — | — |
| nonanoyloxybenzene- | | | | | |
| sulfonate (NOBS) | | | | | |
| Tetraacetylethylenediamine | 1.3 | — | — | — | — |
| (TAED) | | | | | |
| Sodium carbonate | 1.5 | — | — | — | — |
| Citric Acid | 3.5 | 3.7 | 0.5 | 4.5 | — |
| C12-18 Fatty Acid | 2.0 | 3.0 | 4.2 | 1.5 | 6.2 |
| (excluding palmitic acid) | | | | | |
| Palmitic acid (hexadecanoic | 2.5 | 0.5 | — | 4.4 | — |
| acid) | | | | | |
| Sodium bisulfate | — | — | 2.4 | — | 2.1 |
| Water | bal- | bal- | bal- | bal- | bal- |
| | ance | ance | ance | ance | ance |

*“Bcylcam” = 5,12-diethyl-1,5,8,12-tetraazo-bicyclo[6.6.2]hexadecane

What is claimed is:

1. A non-unit dose liquid laundry detergent composition suitable for use in a single- compartment container comprising:
(a) detersive surfactant;
(b) from 0 wt % to 20 wt % water;
(c) source of peracid;
(d) optionally, from 0 wt % to 5 wt % citric acid; and
(e) optionally, from 0 wt % to 5 wt % fatty acid,
wherein the pH of the undiluted composition is at least 0.5 pH units higher than the pKa of the source of peracid,
and wherein upon dilution in de-ionized water to a concentration of 1 g/L at 20° C., the composition forms a wash liquor, wherein the equilibrium pH of the wash liquor is at least 0.5 pH units lower than the pKa of the source of peracid.

2. A composition according to claim 1, wherein the pH of the undiluted composition is at least 1.0 pH unit higher than the pKa of the source of peracid,
and wherein upon dilution in de-ionized water to a concentration of 1 g/L at 20° C., the composition forms a wash liquor, wherein the equilibrium pH of the wash liquor is at least 1.0 pH unit lower than the pKa of the source of peracid.

3. A composition according to claim 1, wherein the pH of the undiluted composition is at least 1.5 pH units higher than the pKa of the source of peracid,
and wherein upon dilution in de-ionized water to a concentration of 1 g/L at 20° C., the composition forms a wash liquor, wherein the equilibrium pH of the wash liquor is at least 1.5 pH units lower than the pKa of the source of peracid.

4. A composition according to claim 1, wherein the composition comprises alkanolammonium compound and an oxaziridinium-based bleach catalyst, and wherein upon dilution in de-ionized water to a concentration of 1 g/L at 20° C., the composition forms a wash liquor, wherein the equilibrium pH of the wash liquor is at least 0.5 pH units lower than the pKa of the alkanolammonium compound.

5. A composition according to claim 4, and wherein upon dilution in de-ionized water to a concentration of 1 g/L at 20° C., the composition forms a wash liquor, wherein the equilibrium pH of the wash liquor is at least 1.5 pH units lower than the pKa of the alkanolammonium compound.

6. A composition according to claim 1, wherein upon dilution in de-ionized water to a concentration of 1 g/L at 20° C., the composition has a pH profile such that:
(i) one minute after dilution in water, the composition forms a wash liquor having an alkaline pH of 9.5 or greater; and
(ii) one hour after dilution in water, the composition forms a wash liquor having an acid pH of 7.6 or less.

7. A composition according to claim 1, wherein the composition comprises sodium bisulphate, and optionally palmitic acid.

8. A composition according to claim 1, wherein the composition comprises sodium bisulphate in solid particulate form, wherein the solid particles of sodium bisulphate are suspended within a continuous liquid phase.

9. A composition according to claim 1, wherein the composition comprises sodium bisulphate and palmitic acid in solid co-particulate form, wherein the palmitic acid at least partially coats the sodium bisulphate, and therein solid co-particles of sodium bisulphate and palmitic acid are suspended within a continuous liquid phase.

10. A composition according to claim 1, wherein the composition comprises bleach catalyst.

11. A composition according to claim 10, wherein the composition comprises oxaziridinium based bleach catalyst.

12. A composition according to claim 10, wherein the composition comprises oxaziridinium based bleach catalyst having the formula: 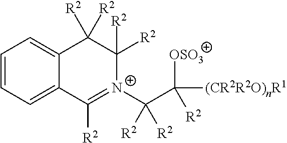
wherein:
R¹ is selected from the group consisting of: H, a branched alkyl group containing from 3 to 24 carbons, and a linear alkyl group containing from 1 to 24 carbons; R² is independently selected from the group consisting of: H, a branched alkyl group comprising from 3 to 12 carbons, and a linear alkyl group comprising from 1 to 12 carbons; and n is an integer from 0 to 1.

13. A composition according to claim 10, wherein the composition comprises a transition metal bleach catalyst.

14. A composition according to claim 10, wherein the composition comprises bleaching enzyme.

15. A composition according to claim 1, wherein the composition comprises a pre-formed peracid.

16. A composition according to claim 1, wherein the composition comprises a phthalimido peroxy caproic acid.

17. A composition according to claim 1, wherein the detersive surfactant comprises anionic detersive surfactant and non-ionic detersive surfactant, and wherein the weight ratio of anionic detersive surfactant to non-ionic detersive surfactant is greater than 1:1.

18. A composition according to claim 1, wherein detersive surfactant comprises alkanolammonium neutralised anionic detersive surfactant.

19. A composition according to claim 1, wherein the composition comprises perfume in microcapsule form.

20. A composition according to claim 1, wherein the composition comprises hueing agent.

21. A composition according to claim 1, wherein the composition comprises a variant of Thermomyces lanuginosa lipase having >90% identity with the wild type amino acid and comprising substitution(s) at T231 and/or N233.

22. A composition according to claim 1, wherein the composition comprises polyamine.

23. A composition according to claim 1, wherein the compostion is in the form of a gel.

24. A non-unit dose liquid laundry detergent composition suitable for use in a single-compartment container comprising:
(a) detersive surfactant;
(b) from 0 wt % to 20 wt % water;
(c) source of peracid;
(d) oxaziridinium-based bleach catalyst having the formula: 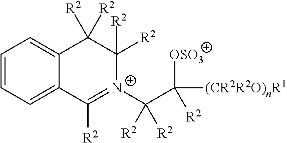
wherein:
R¹ is selected from the group consisting of: H, a branched alkyl group containing from 3 to 24 carbons, and a linear alkyl group containing from 1 to 24 carbons; R² is independently selected from the group consisting of: H, a branched alkyl group comprising from 3 to 12 carbons, and a linear alkyl group comprising from 1 to 12 carbons; and
n is an integer from 0 to 1;
(e) alkanolammonium compound;
(f) optionally, from 0 wt % to 5 wt % citric acid; and
(g) optionally, from 0 wt % to 5 wt % fatty acid,
wherein the pH of the undiluted composition is at least 1.0 pH unit higher than the pKa of the source of peracid,
wherein upon dilution in de-ionized water to a concentration of 1 g/L at 20° C., the composition forms a wash liquor, wherein the equilibrium pH of the wash liquor is at least 1.0 pH unit lower than the pKa of the source of peracid,
wherein upon dilution in de-ionized water to a concentration of 1 g/L at 20° C., the composition forms a wash liquor, wherein the equilibrium pH of the wash liquor is at least 2.0 pH units lower than the pKa of the alkanolammonium compound;
wherein upon dilution in de-ionized water to a concentration of 1 g/L at 20° C., the composition has a pH profile such that:
(i) one minute after dilution in water, the composition forms a wash liquor having an alkaline pH of 9.5 or greater; and
(ii) one hour after dilution in water, the composition forms a wash liquor having an acid pH of 7.6 or less.
